(19) United States
(12) Patent Application Publication
(10) Pub. No.: US 2008/0220201 A1
(43) Pub. Date: Sep. 11, 2008

(54) Cloth Carpet

(76) Inventor: Tadeusz Wieckowski, Miedzyrzeeze Dolne (PL)

Correspondence Address: POWER DEL VALLE LLP, 233 WEST 72 STREET, NEW YORK, NY, 10023, US

(21) Appl. No.: 10/598,085

(22) PCT Filed: Feb. 21, 2005
(86) PCT No.: PCT/PL2005/000011

§ 371 Date: Aug. 17, 2006

(30) Foreign Application Priority Data
Feb. 27, 2004 (PL) P 365658

(51) Int. Cl. B32B 33/00

(52) U.S. Cl. 428/96

(57) ABSTRACT

The object of the invention is a cloth carpet. The cloth carpet is characterised by the fact that at least one layer, usually the surface one, is made of a cloth (1) of basis weight between 1100 and 1500 g.s.m. produced of yarn of 100% wool or yarn made of wool with ca. 10% admixture of popular textile fabrics, combined by gluing, sewing, tufting or milling with a second cloth layer (2) or an industrial fabric (3).

The object of the invention is a cloth carpet.

Textile fitted carpets, which have the form of products manufactured by knotting, weaving, knitting or tufting textiles with yarn, are popular. That product group includes carpets made of unwoven cloth tufted with yarn produced of primary backing of woven cloth or knitted fabric, usually made of polypropylene or polyester with fleece yarn sewn on or needled to it. Lining fabric called the back, coated underside with latex or synthetic glue, is used for preserving loops of spun yarn fibre.

Higher quality carpets often have a second back made of woolen felt that can be glued or sewn together with the first one. Examples of textile fitted carpets, especially a carpet, were described in a German Patent Application No. DE 100 48 152 C1 and in a German Application for a Utility Model No. DE 200 22 177 U1, where woolen felt, provided on its upper side with yarn sections forming fleece, is used as the lining fabric. Thus a carpet has an upper surface, which includes both woolen felt areas and those of fleece. Fleece surface can be flat-formed and also three-dimensionally formed in various ways by point-gluing of yarn sections, their needling, sewing on or gluing onto the lining fabric in the form of woolen felt.

The aim of the invention is to widen the market offer of handicraft carpets, characterised by a very high capacity of maintaining their initial shape and consequently, resistant to repeated rolling and unrolling and enabling obtaining various plastic and aesthetic forms by combining the base cloth with varied fabrics, which offers a possibility to create a new type of double-faced carpet.

The cloth carpet according to the invention, is formed of at least two inseparable layers combined in a popular way, and it is characterised by the fact that at least one layer, usually the surface one, is made of cloth of basis weight between 1100 and 1500 g.s.m. produced of yarn of 100% wool or yarn made of wool with 10% admixture of popular textile fabrics, combined by gluing, sewing, tufting or milling with a second layer of cloth or industrial fabric, with fabrics that form fleece cover or pattern elements on the surface, flush with the surface or below the cloth surface, and textile pieces, strips, flat designs, appliqués or convex designs that are fixed to the cloth surface by gluing, sewing or milling. Cloth layer is made of milled woolen woven fabric with part of weft and/or warp threads made of non-woolen fabrics and with cloth layer made of milled woolen woven fabric that is covered with painted graphic designs and combined with a layer of regular cloth or a layer of industrial fabric and all the layers are tufted, glued, sewn or milled. Cloth layer has notches with patches of fleece, in the form of fine yarn, or spun woolen yarn, woven fabrics, fabrics produced by knotting or by pressing into woven fabric structure, which are glued into them.

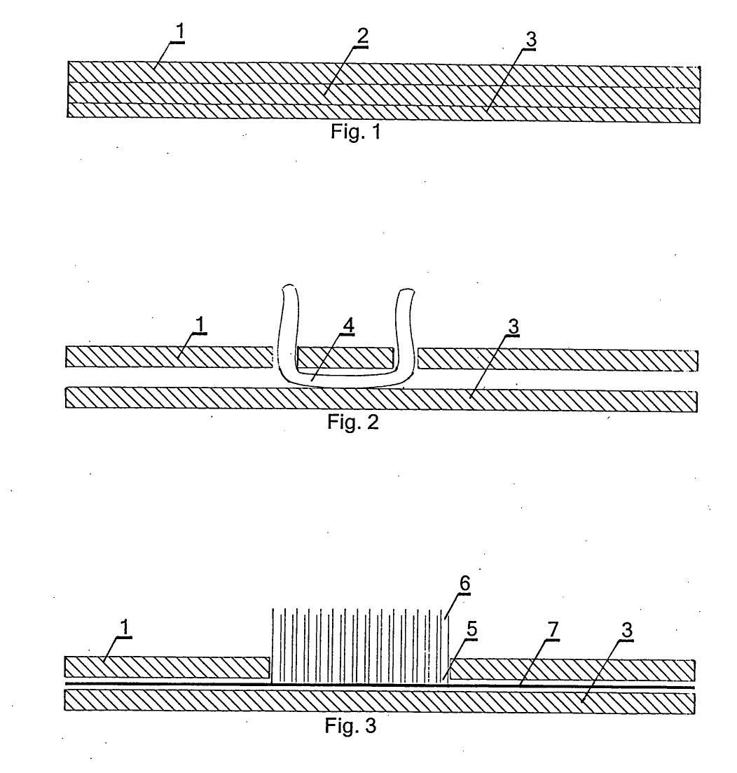

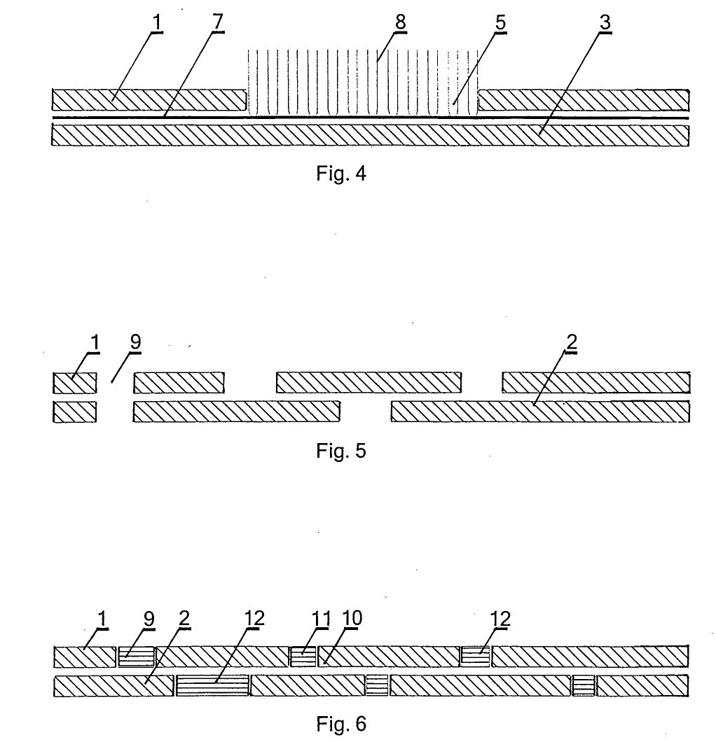

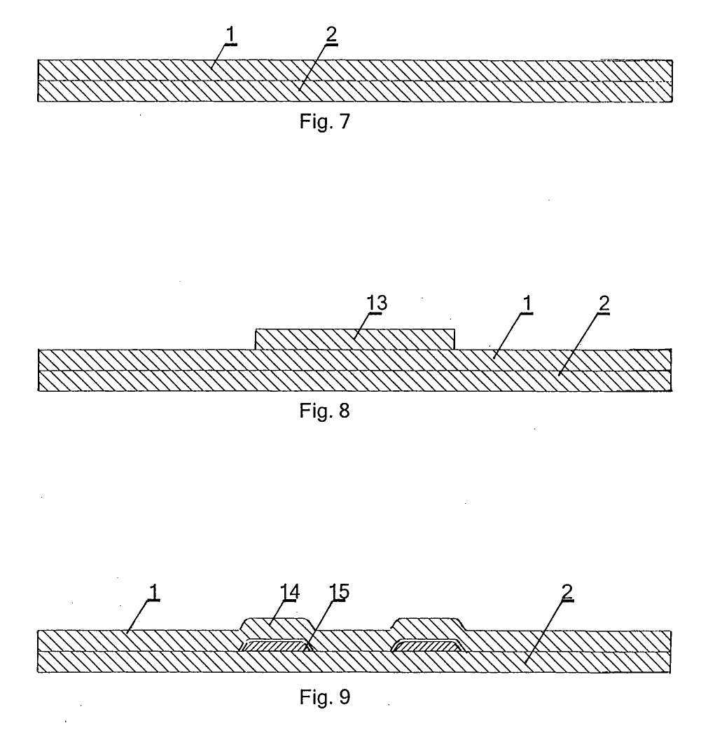

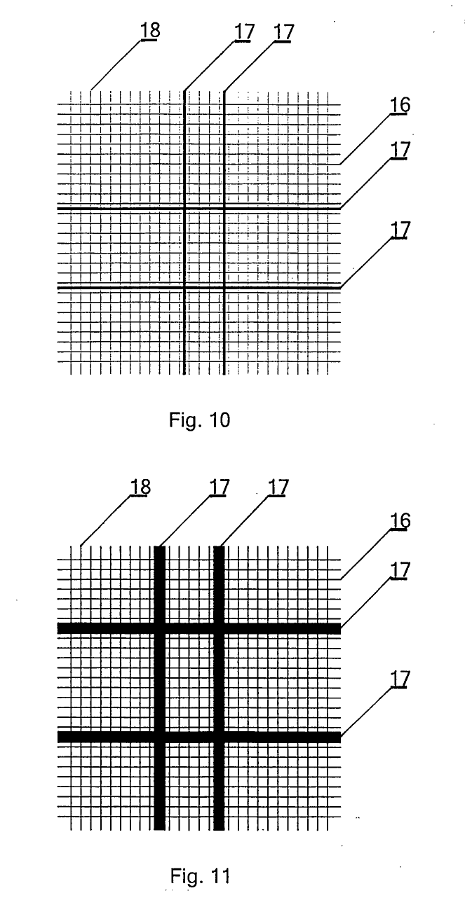

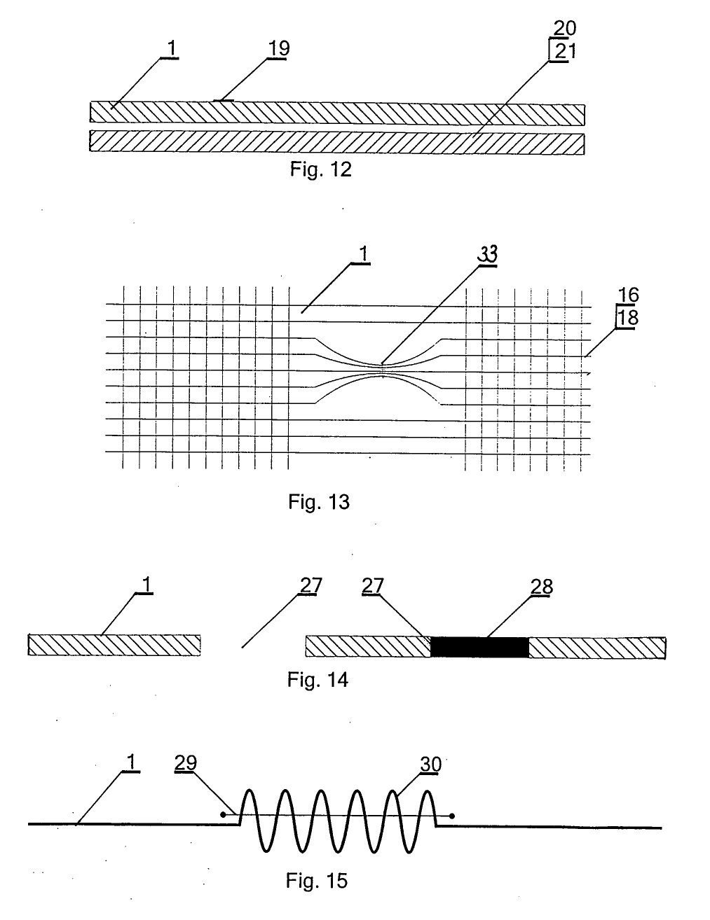

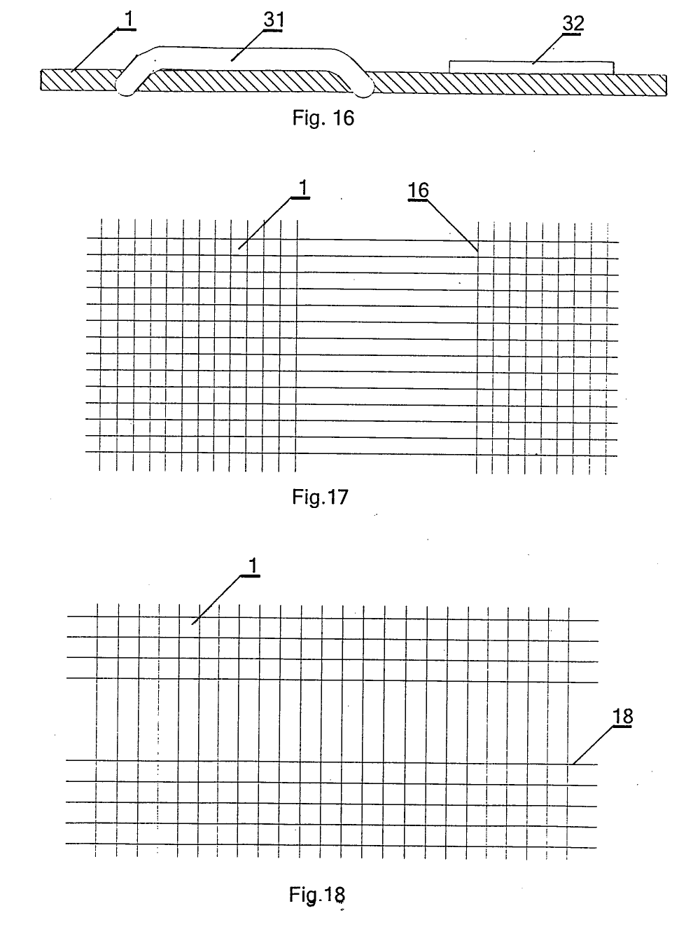

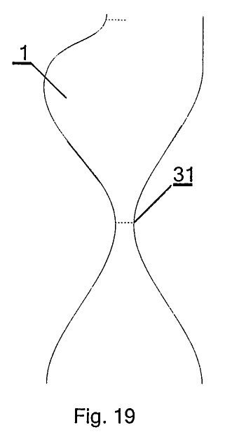

The object of the invention is presented in example products in an attached drawing, where FIG. 1—shows a cloth carpet composed of a cloth layer 1 combined with a second layer of cloth 2 and a layer of industrial fabric 3, which are joined by gluing, sewing or milling; FIG. 2—shows a cloth carpet composed of a cloth layer 1 interwoven with textile elements 4 and a layer of industrial fabric 3 combined by gluing, sewing or milling; FIG. 3—shows a cloth carpet composed of a cloth layer 1 with notches 5 prepared for gluing in patches of fleece 6 made of fine woolen yarn or other fabrics forming a fleece item, visible on the upper side, preferably manufactured on a loom or by knotting or pressing into the woven fabric surface, while fleece items 6 are produced on the woven fabric 7 and glued to the industrial fabric 3; FIG. 4—shows a cloth carpet composed of a cloth layer 1 with notches 5 prepared for gluing in strips 8 of a width of 5 to 25 mm, cut along the warp or weft, which are then woven on a loom, knotted or pressed into the woven fabric 7 forming a fleece of any height, which is a ready surface of the whole carpet, and also a carpet element, protected underside with a layer of the industrial fabric 3; FIG. 5—shows a cloth carpet composed of glued or sewn cloth layers 1 and a cloth layer 2 which have various graphic designs 9 cut, where outer layers of the carpet, glued in that way, are the surfaces intended to be used as a double-faced carpet; FIG. 6—shows a cloth carpet composed of a cloth layer 1 and a cloth layer 2 which have various graphic designs 9 cut and both 1 and 2 cloth layers are glued or sewn, and the hollows 10 formed in the surface are filled, by gluing or sewing, with identical designs 11 made of different colour cloth or with an element 12 made of a different fabric, where outer surfaces of the carpet, glued in that way, are the surfaces intended to be used as a double-faced carpet; FIG. 7—shows a cloth carpet composed of a cloth layer 1 combined by hand or machine sewing with a cloth layer 2, with traces of regular sewing or sewing according to a model left on the fleece surface, and the outer carpet surfaces are the surfaces intended to be used as a double-faced carpet; FIG. 8—shows a cloth carpet composed of a cloth layer 1 and a cloth layer 2, where cut-out appliqués 13 are sewn on or glued into the surface of the cloth layer 1; FIG. 9—shows a cloth carpet composed of a cloth layer 1 and a cloth layer 2, where convex figures 14 are formed in the cloth layer 1 by pressing or stamping, and they are complemented with different fabrics 15 that support their convex form in area of convexity; FIG. 10—shows a cloth fabric 1, where apart from warp threads 16 or weft threads 18 there are some non-woolen fabrics 17; FIG. 11—shows a cloth fabric 1, where non-woolen fabrics 17 are the threads of weft 18 and warp 16; FIG. 12—shows a cloth carpet composed of a cloth layer 1 covered with painted graphic designs 19, combined with a layer of a regular cloth 20 or a layer of industrial fabric 21, where layers 1, 20 and 21 are tufted, glued, sewn or milled; FIG. 13—shows a cloth fabric 1 with some warp threads 16 or weft threads 18 cut out and the other warp threads 16 or weft threads 18 knotted with a thread 33 or spliced with the thread 33 and then milled and dried; FIG. 14—shows a cloth layer 1 with cut-out openings 27, whose edges are left in that form until milling or where woven fabrics 28 or some other fabric 28 are sewn into or inserted into those openings 27 or sewn on those openings 27; FIG. 15—shows a cloth layer 1 tufted in varied directions with a thread 29, which forms a crease 30 in place of tufting that is then milled and dried; FIG. 16—shows a cloth layer 1 with woolen elements 31 or elements of other fabrics 32 sewn on or interwoven into the outer and inner layers where the cloth layer 1 is then milled and dried; FIG. 17—shows a cloth fabric 1 with partly removed warp threads 16, which form some design items after milling; FIG. 18—shows a cloth fabric 1 with removed weft threads 18, which form some design items after milling; and FIG. 19—shows a cloth fabric 1 where the intended result of uneven colouration of surface 34 is achieved by twisting on the length and contracting on the twist circumference with the thread 33 and dyeing the fabric in that form in the hank dyeing machine.

1. A cloth carpet composed of at least two inseparable layers combined in a popular way, characterised by the fact that at least one layer, usually the surface one, is made of a cloth (1) of basis weight between 1100 and 1500 g.s.m. produced of yarn of 100% wool or yarn made of wool with ca. 10% admixture of popular textile fabrics, combined by gluing, sewing, tufting or milling with a second cloth layer (2) or an industrial fabric (3).

2. The carpet according to the claim 1, characterised by the fact that fabrics that form fleece cover or design items are placed on the surface, at the surface level or below the surface of the cloth (1).

3. The carpet according to the claim 1, characterised by the fact that textile pieces (4) and/or fleece pieces (6) and/or strips (8) and/or flat patches (11) and/or elements (12) and/or flat appliqués (13) and/or convex designs (14) are fixed to the cloth surface (1) by gluing, sewing or milling.

4. The carpet according to the claim 1, characterised by the fact that the cloth layer (1) is formed of a milled woolen woven fabric with part of threads of weft (18) and/or warp (16) are made of non-woolen fabrics (17).

5. The carpet according to the claim 1, characterised by the fact that the cloth layer (1) made of milled woolen woven fabric is covered with painted graphic designs (19) and combined with a regular cloth layer (20) or an industrial fabric layer (21) where layers (1), (20) and (21) are tufted, glued, sewn or milled.

6. The carpet according to the claim 1, characterised by the fact that, the cloth layer (1) has some notches (22) which are filled with fleece pieces in the form of fine woolen yarn (23) or spun yarn (23), woven fabrics (24), fabrics manufactured by knotting (25) or fabrics manufactured by pressing into a fabric structure (26).
